(19) United States
(12) Patent Application Publication
(10) Pub. No.: US 2016/0127408 A1
(43) Pub. Date: May 5, 2016

(54) DETERMINING VULNERABILITY OF A WEBSITE TO SECURITY THREATS

(71) Applicant: NxLabs Limited, Hong Kong (CN)

(72) Inventors: Tony Miu, Hong Kong (CN); Reggie Yam, Hong Kong (CN); Elmer Supan, Hong Kong (CN); Wai Leng Lee, Hong Kong (CN); Ryan Chin, San Jose, CA (US)

(21) Appl. No.: 14/530,509

(22) Filed: Oct. 31, 2014

(51) Int. Cl. H04L 29/06

(52) U.S. Cl. CPC H04L 63/1433; H04L 63/1458

(57) ABSTRACT

Provided are methods and systems for determining a vulnerability of a website to at least one security threat. An example method can comprise providing a user interface; receiving, via the user interface, website data associated with the website; based on the website data, probing the website with at least one request, with the at least one request including at least one security threat signature; receiving at least one response from the website; comparing the least one response to at least one expected response for the at least one request; based on the comparison, determining the at least one security threat; and reporting results of the determination for review.

### TECHNICAL FIELD

This disclosure relates generally to data processing and, more specifically, to methods and systems for determining a vulnerability of a website to security threats.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Attacks on enterprise networks and popular sites are common and pose a risk to the health and stability of companies, organizations, governments, and even individuals with a prominent web presence that rely on the Internet for their business. Enterprises today rely heavily on their Internet data centers to keep their businesses up and running and their customers' orders coming in, including e-commerce, gaming, social networking, online financial services, web hosting, retail, and healthcare.

Realizing risks associated with such attacks, various mitigation strategies have been developed that follow predetermined routines for disaster recovery and incident response. Most of such strategies deal with various network attacks, for example, Distributed Denial of Service (DDoS) attacks, much the same way as a company would deal with a natural disaster. This approach generally assumes that certain consequences of an attack are inevitable, and therefore, companies focus on quick recovery instead of risk evaluation and prevention.

However, some sites can be much more vulnerable to attacks than others due to the site-specific architecture, data protection level, and dynamic mitigation measures taken while an attack is in progress. Additionally, it is difficult to estimate consequences of an attack for a specific site in advance.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiment of the disclosure, a method for determining a vulnerability of a website to at least one security threat is provided. The method can include providing a user interface (UI); receiving, via the UI, website data associated with the website; based on the website data, probing the website with at least one request, with the at least one request including at least one security threat signature; receiving at least one response from the website; comparing the least one response to at least one expected response for the at least one request; based on the comparison, determining the at least one security threat; and reporting results of the determination for review.

The at least one request can include at least one of the following: a Hypertext Transfer Protocol (HTTP) request, a Hypertext Transfer Protocol Secure (HTTPS) request, and a Transmission Control Protocol (TCP) request. The security threat can include a DDoS attack. The results of determination can be reported to a user associated with the website. The report can include at least one of the following: a list of top vulnerabilities and a comparative analysis of the website with respect to at least one similar website. The at least one similar website can be determined based on data received from a third party web traffic data provider. The method can further include providing a management portal.

The results can be provided in a predetermined format and include further information associated with the at least one security threat. The method can further include advertising further services associated with the at least one security threat. The least one security threat signature can be received from a database or a third party provider. The method can further include determining whether previously generated results exist for the website and, based on the determination, selectively provide the previously generated results. The method can further include ranking the at least one security threat.

The method can further include classifying the at least one security threat into categories based on corresponding security threat levels. The at least one security threat signature includes at least one of the following: a code, a name, a category, a publication date, an emergence of the attack, a geo location of a botnet, a severity, a gravity of impact, and an attack pattern. The probing of the website with the at least one request can be performed within a predetermined time period to prevent the website from implementing countermeasures. The results include at least one of the following: a brief description of the results, security threats, and risks. The method can further include analyzing the at least one security threat on a predetermined periodic basis.

According to another example embodiment a system for determining a vulnerability of a website to at least one security threat is provided. The system can include a processor configured to provide a UI; receive, via the UI, website data associated with the website; based on the website data, probe the website with at least one request, with the at least one request including at least one security threat signature; receive at least one response from the website; compare the least one response to at least one expected response for the at least one request; based on the comparison, determine the at least one security threat; and report results of the determination for review. The at least one request can include at least one of the following: an HTTP request, an HTTPS request, and a TCP request. The security threat can include a DDoS attack.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which methods for determining a vulnerability of a website to security threats can be practiced.

FIG. 2 is a block diagram of a system for determining a vulnerability of a website to security threats.

FIG. 3 is a process flow diagram showing a method for determining a vulnerability of a website to security threats.

FIG. 4 illustrates interactions between a user and a system for determining a vulnerability of a website to security threats.

FIG. 5 is a flow diagram illustrating a method for requesting a DDoS assessment report.

FIG. 6 is a flow diagram illustrating a method for requesting a manual scan of a website.

FIG. 7 is a flow diagram illustrating a DDoS assessment enquiry.

FIG. 8 shows a user interface of a system for determining a vulnerability of a website to security threats.

FIG. 9 shows another user interface of a system for determining a vulnerability of a website to security threats.

FIG. 10 shows yet another user interface of a system for determining a vulnerability of a website to security threats.

FIG. 11 illustrates an example computer system that may be used to implement embodiments of the present disclosure.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

Methods and systems for determining a vulnerability of a website to security threats are provided. In one embodiment of the disclosure, a method can enable assessing attack (e.g., a DDoS) consequences with respect to a specific website to enable companies to judge their vulnerability to such attacks. A system can provide users with knowledge of the latest attack methodologies, gain insight of the web service security threats and vulnerability and to showcase services directed to mitigation of web security threats.

A UI can be provided for a user to enter information related to a website. The UI can be implemented without restriction to users by providing free access to the assessment tool without requiring login credentials. The UI can be used for initial assessment of basic information about web service vulnerability. A system for determining a vulnerability of a website to security threats serving as a scanning engine can be utilized to scan the website. The results of scanning can be analyzed and an assessment report can be provided to a user. The purpose of the scanning is to identify the DDoS vulnerabilities found on the website. The results of the scanning provide users with an analysis of website vulnerabilities, allow users to gain an understanding of different security threats and recommend countermeasures for reduction or mitigating the security threat.

More specifically, the UI can enable users to request scans of the websites and receive informative results such as, for example, top 10 vulnerabilities found on the website, comparative analysis by percentage, and the total scanned information. The UI can allow users to enter a website address and scan the website by clicking on a “scan” button on the UI. The UI on a standalone website can be used for easy access and may not require any credentials.

Upon receiving the scanning request, the user can be notified that there have not been any scans of the website so that the user can order a new scan. The system can query the database of previously scanned active websites and compare vulnerabilities between the previous scanned websites and the websites provided by the user. The information can be presented in an easy to understand format. Furthermore, the user can be allowed to review related searches. The users can be allowed to see all scanned results with a high level breakdown of the current vulnerabilities scanned by the system. The results can be ranked to provide top vulnerabilities found. Corresponding percentages illustrating vulnerabilities, popularity, and Google page rankings can be provided. As used herein, “page rank” is the current rank of the website based on importance and popularity.

An assessment report can be provided to the user upon request and after being validated by the system. Upon validation, the assessment report can be provided to users in various formats. In the assessment report, basic information of the website being scanned can be provided such as, for example, an Internet Protocol (IP) address and an autonomous system (AS) number.

The scanning is not intended to scan all known systems and services or identify all vulnerabilities. The assessment performed can be focused on DDoS related vulnerabilities limited to TCP, HTTP and HTTPS services. The method can perform a non-intrusive probing of main website and then obtain a response from a server associated with the website.

A denial of service (DoS) or DDoS attack includes an attempt to make a machine or network resource unavailable to its intended users. The most common types of DoS attacks are volume-based attacks (e.g. User Datagram Protocol (UDP) and Internet Control Message Protocol (ICMP) Flood), Protocol Attacks (Transmission Control Protocol (TCP) SYN Flood), and Application Layer Attack (HTTP GET Flood, Domain Name System (DNS) and Network Time Protocol (NTP) Attack, Slowloris).

Botnet or Bot is short for robot. A Botnet or Bot is a network of computers infected with malicious software and controlled as a group without knowledge of an owner that can turn a computer into a bot, also known as a Zombie. Botnets are prevailing mechanisms for facilitating DDoS attacks on computer networks or applications.

Vulnerability is a weakness that allows an attacker to reduce information assurance or performance of the system. A DDoS assessment report includes a report that is sent to a user upon request and after a validation process. Alexa Ranking is a web traffic data company that provides rankings, conducts audits, and makes public the frequency of visits on various websites.

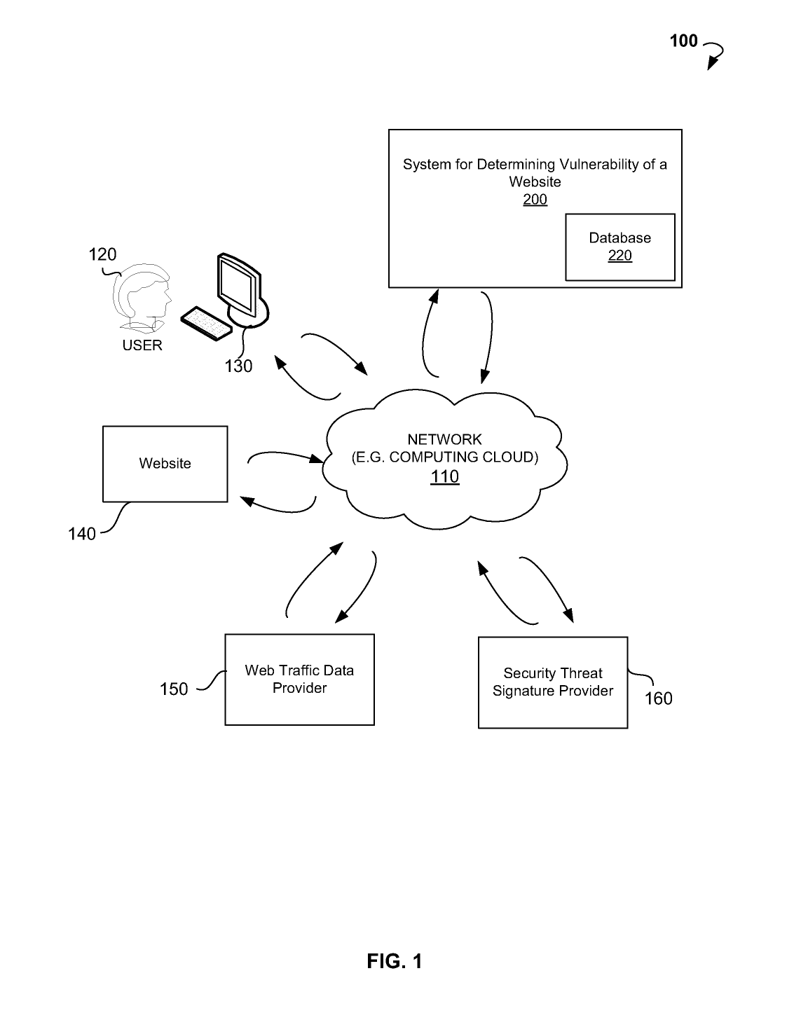

Referring now to the drawings, FIG. 1 shows an environment 100 within which methods for determining a vulnerability of a website to security threats can be practiced. The environment 100 may include a network 110, a user 120, a user device 130 associated with the user 120, a website 140, a system 200 for determining a vulnerability of a website to security threats, a web traffic data provider 150, and a security threat signature provider 160. The website 140 may be associated with the user 120 and may include a network resource that is in need of determining a vulnerability to security threats.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may include a network of data processing nodes that are interconnected for the purpose of data communication.

The system 200 may provide the user 120 with a UI (not shown). The UI may be displayed on the user device 130. Using the UI, the user 120 may provide website data associated with the website to the system 200. The system 200 may receive the website data and initiate probing of the website 140 with a request including a security threat signature. The security threat signature may be received from a database 220 associated with the system. Alternatively, the security threat signature may be received from the security threat signature provider 160. In response to probing, the system 200 may receive the response from the website 140 and compare the response to an expected response. Based on the comparison, the system 200 may determine the security threat for the website 140 and report results of the determination to the user 120. The report may include a comparative analysis of the website 140 with respect to a similar website. The one similar website may be determined based on data received from the web traffic data provider 150.

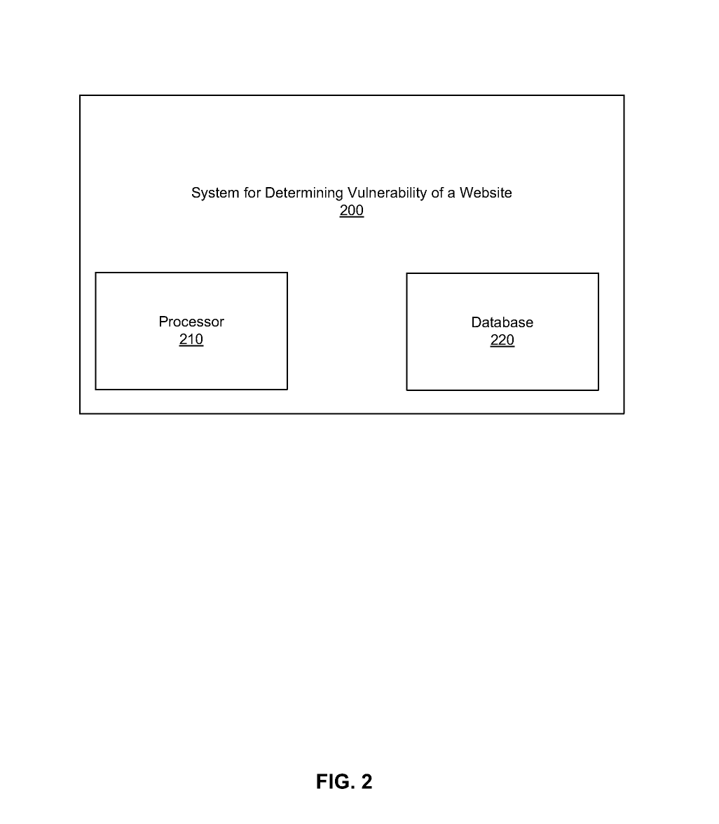

FIG. 2 is a block diagram of a system 200 for determining a vulnerability of a website to security threats, according to an example embodiment. The system 200 may include a processor 210 and a database 220. The processor 210 may be configured to provide a UI. After providing the UI, the processor 210 may be configured to receive, via the UI, website data associated with the website. Based on the website data, the processor 210 may be configured to probe the website with at least one request. In an example embodiment, the at least one request includes at least one of the following: an HTTP request, an HTTPS request, and a TCP request. In an example embodiment, the probing of the website with the request is performed within a predetermined time period to prevent the website from implementing countermeasures.

The at least one request may include at least one security threat signature. In an example embodiment, a security threat includes a DDoS attack. The security threat signature may be received from the database 220 or a third party provider. In an example embodiment, the security threat signature includes at least one of the following: a code, a name, a category, a publication date, an emergence of the attack, a geo location of a botnet, a severity, a gravity of impact, and an attack pattern.

In response to probing the website, the processor 210 may be configured to receive at least one response from the website. The processor 210 may be configured to compare the at least one response to at least one expected response for the at least one request. Based on the comparison, the processor 210 may be configured to determine the at least one security threat.

The processor 210 may be configured to report results of the determination for review. The results may be provided in a predetermined format. In an example embodiment, the results of determination are reported to a user associated with the website. The report may include at least one of the following: a list of top vulnerabilities and a comparative analysis of the website with respect to at least one similar website. The similar website may be determined based on data received from a third party web traffic data provider. The results may include further information associated with the at least one security threat. The results may include a brief description of the results, security threats, risks, and so forth.

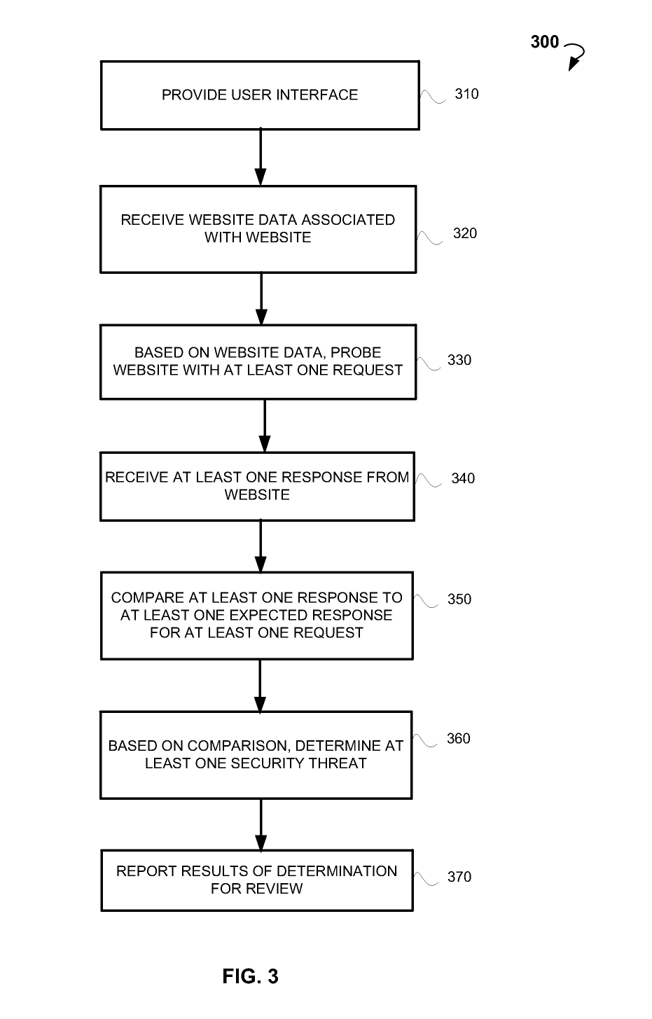

FIG. 3 is a process flow diagram showing a method 300 for determining a vulnerability of a website to security threats, according to an example embodiment. The method may commence with providing a UI at operation 310. At operation 320, the method 300 may include receiving, via the UI, website data associated with the website.

The method 300 may continue with probing, based on the website data, the website with at least one request at operation 330. The probing can be also referred to as “scanning.” The request may include at least one of the following: an HTTP request, an HTTPS request, and a TCP request. The at least one request may include at least one security threat signature. The security threat may include a DDoS attack. In an example embodiment, the at least one security threat signature is received from a database or a third party provider. In general, the DDoS assessment can include a large quantity of security threat signatures. In an example embodiment, the security threat signature includes at least one of the following: a code, a name, a category, a publication date, an emergence of the attack, a geo location of a botnet, a severity, a gravity of impact, an attack pattern used to probe the website, and additional information about the security threat signature. The probing of the website with the request may be performed within a predetermined time period to prevent the website from implementing countermeasures.

In an example embodiment, the scanning may include interaction with third party services such as, for example, Google Application Programming Interface (API) and Alexa website, during the batch scan. The method 300 may include DDoS attack tools and botnet signatures to classify the security threats into a number of categories such as, for example, 3 categories such as Simple, Intermediate, and Advanced. The Simple category can include common security threats related to common TCP communications, which are violations that can be easily mitigated by normal DDoS mitigation process. The Advanced category can include sophisticated botnets that use technologies such as Secure Sockets Layer (SSL) connection and cryptography to prevent packet sniffing, data inspection, and analysis.

A scan of the website can resolve DNS of the website and also get the AS number of the corresponding IP. The method 300 can implement the handling of the cookies and response status code such as, for example, HTTP 301 (moved permanently) or HTTP 302 (Uniform Resource Locator (URL) redirection) to guarantee that the updated URL is based on the final URL path and IP address.

In some embodiments, the method 300 can send packets with various security threat signatures to each of the target websites and analyze the response as quickly as possible to prevent blocking at the server end.

At operation 340, the method 300 may include receiving at least one response from the website. The method 300 may continue with comparing the at least one response to at least one expected response for the at least one request at operation 350. The expected responses may be present for different security threat signatures. Furthermore, the comparing can be based on data received from a third party, such as, for example, Alexa, as well as expected responses for different security threat signatures (e.g. Apache killer can respond HTTP 206 from the server side).

In an example embodiment, third party assessment tools are used in conducting a vulnerability assessment. A customized tool can perform a non-intrusive probing of main website to gather information from its random destination target by sending a signature-based HTTP request and comparing a response from the target to an expected response.

At operation 360, the at least one security threat may be determined based on the comparison. The method 300 may further include reporting results of the determination for review at operation 370. In an example embodiment, the results of determination are reported to a user associated with the website. A report may include at least one of the following: a list of top vulnerabilities and a comparative analysis of the website with respect to at least one similar website. In an example embodiment, the similar website is determined based on data received from a third party web traffic data provider. In a further example embodiment, the results are provided in a predetermined format, such as in a graph format, a tabular format, and so forth. The results may include further information associated with the at least one security threat. In an example embodiment, the results include at least one of the following: a brief description of the results, security threats, and risks. In a further example embodiment, statistics are built to forecast the DDoS attack.

The risks may be divided into several levels, such as High, Medium, and Low. The High level risk may be determined in a case where a threat source is highly motivated and sufficiently capable, and measures that prevent the vulnerability from being exercised are ineffective. The Medium level risk may be determined in a case where the threat source is motivated and sufficiently capable, but measures are in place that may impede a successful exercise of the vulnerability. The Low level risk may be determined in a case where the threat source lacks motivation or capability, and measures are in place to prevent or significantly impede the vulnerability from being exercised.

The method 300 may further optionally include advertising further services associated with the at least one security threat. The results of determining the security threat can be stored in a database. Invalid statuses of the results may assume the following security restrictions: firewall issues or security policies, incomplete HTTP/TCP communication (early terminations such as server send all RST traffic or RST ACK to close the connection). The connection can be closed within 5 seconds of no TCP/HTTP reply to prevent the website from taking mitigating measures.

The method 300 may further optionally include analyzing the at least one security threat on a predetermined periodic basis. For this purpose, the database includes a large quantity of DDoS attack tools and botnet signatures, vulnerabilities, and loopholes that are received and updated periodically. A subscription service can be established to scan websites on a periodic basis. A scan can be performed each time there is an update of a DDoS botnet signature.

The method 300 may further optionally include ranking the at least one security threat. More specifically, the response of the server associated with the website can be matched to the database records to generate a ranking result of security threats and, therefore, top vulnerabilities. In particular, the vulnerability ranking of the website can be established by using the large quantity of active DDoS attack tools and botnet signatures, known vulnerabilities, and loopholes that are stored in the database and researched, gathered, and updated periodically. The ranking result can be based on the top vulnerabilities scanned and matched to the security threat signatures in the database or obtained from a third party security threat signature provider.

Additionally, the method 300 may optionally include determining whether previously generated results exist for the website. Based on the determination, the previously generated results may be selectively provided to the user.

In an example embodiment, the method 300 optionally includes providing a management portal. Using the management portal, the user may review the determined security threats associated with the website, request for determining the security threat of any other website, and so forth.

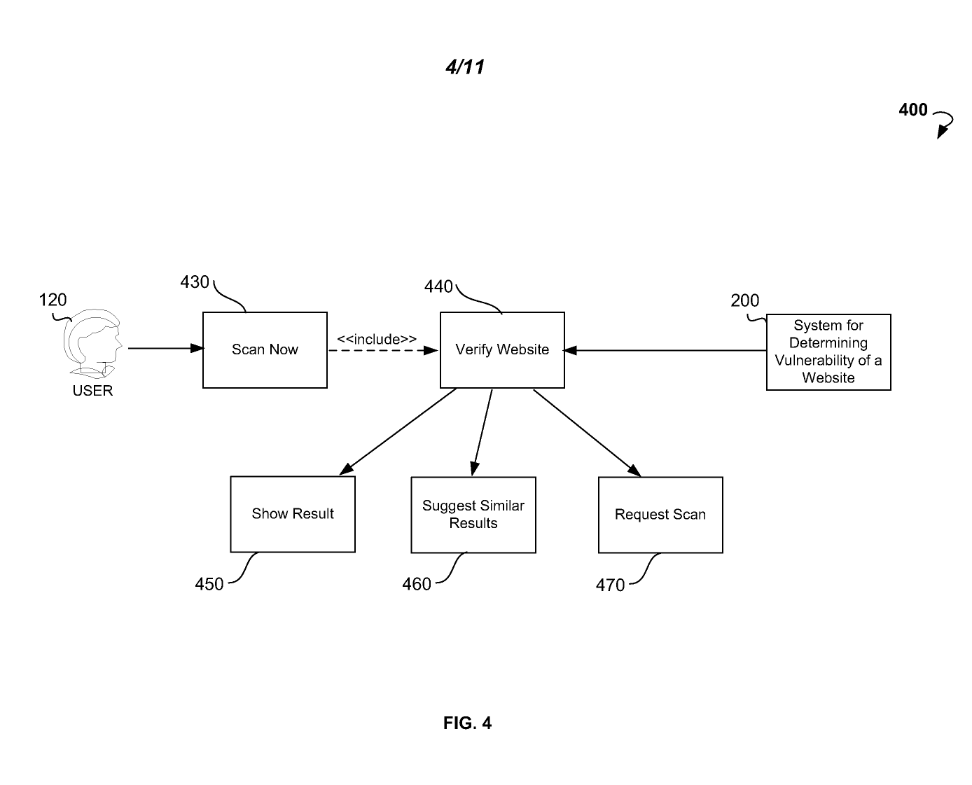

FIG. 4 is a representation 400 of interaction between a user 120 and a system 200 for determining a vulnerability of a website to security threats, according to an example embodiment. The system 200 may act as a scanning engine.

At block 430, the user 120 may trigger scanning of a website to determine a vulnerability of the website to security threats. More specifically, the user 120 can input website data on a scan field and click a “scan now” button using a UI (not shown). If the website is not included in the database of the system 200, the system 200 may return a message that the website has not been scanned yet. The user 120 may have an option of requesting a scan by clicking on “request scan” button, providing the Domain/URL and e-mail address, and performing completely automated public Turing test to tell humans from computers apart (CAPTCHA).

The user 120 can be provided with an option to select similar websites that have been previously scanned by the system 200. The user 120 can click on the provided websites in the list to begin scanning. Otherwise, the user 120 can click a “Request Scan Now” button to request a new website scan.

The scanning of the website is verified by the system 200 at block 440. The system 200 can show results of the scanning based on the vulnerabilities, by percentages of popularity, and/or Google page ranking. After the verification of the website, the system 200 can provide options, which are: “show result” shown at block 450, “suggest similar results” shown at block 460, and “request scan” shown at block 470.

More specifically, the “show result” option can provide the user 120 with brief information concerning website vulnerabilities. The “suggest similar results” option can provide a list of similar websites to the user 120 with an option to choose among the lists of possible websites to be scanned. The “Request Scan” option provides the user with the ability to request a manual scan of the website and be included in the database of scanned websites. Furthermore, the user 120 can submit a request for a DDoS assessment report by clicking a “Submit a Request” link (not shown) by supplying necessary information such as an e-mail address and CAPTCHA. To get a copy of the scanned results, the user 120 can click the “Submit a Request” link and provide user contact information. A copy of the request can be send to the user 120 after a validation process. If a detailed assessment is desired, a separate request can be made.

The “websites scanned” data included into the DDoS assessment report may indicate the total websites scanned by the system 200. “Vulnerabilities found” data may present the total number of vulnerabilities that have been matched to the database. Websites can have multiple vulnerabilities.

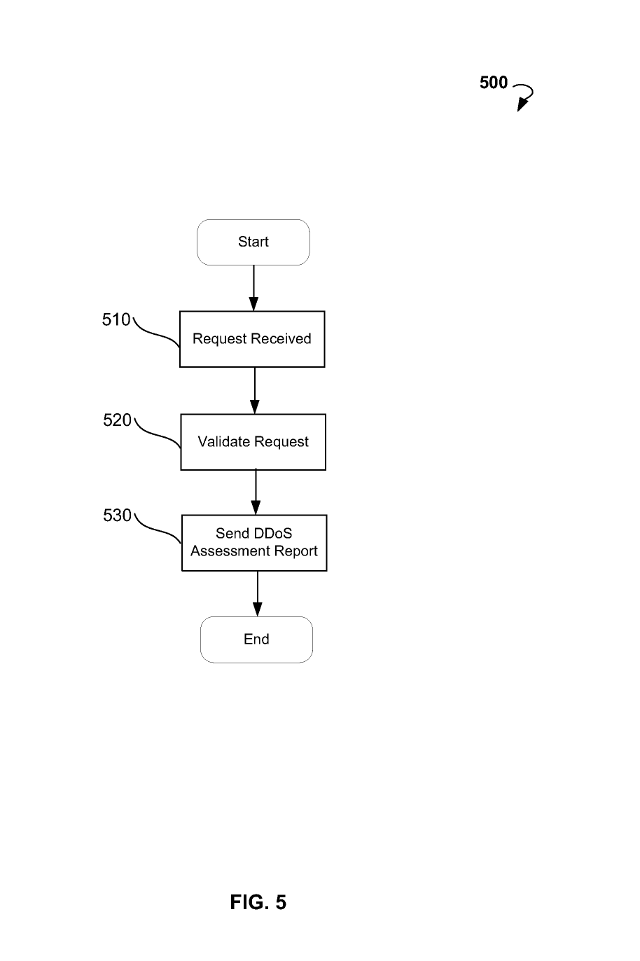

FIG. 5 is a flow diagram 500 illustrating a requesting for a DDoS assessment report, according to an example embodiment. The user may send a request for a DDoS assessment report. The system for determining a vulnerability of a website to security threats may receive the request at block 510. In an example embodiment, the request is received via e-mail or phone. At block 520, the system for determining a vulnerability of a website to security threats may validate the request. Upon validation, the system for determining a vulnerability of a website may send the DDoS assessment report to the user at block 530.

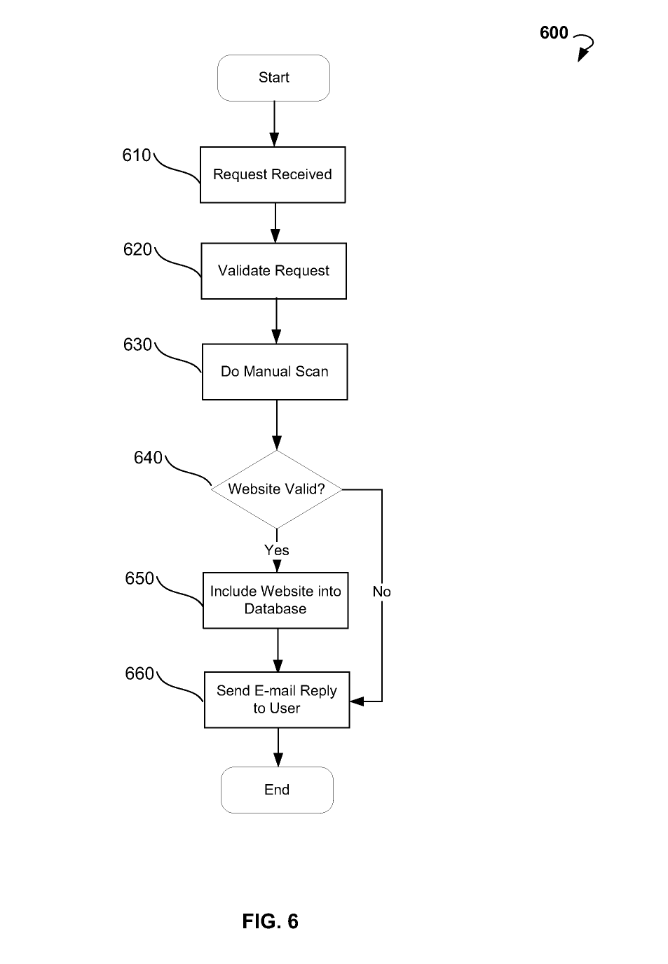

In the case of receiving a message that the website has not been scanned yet, the user may request a manual scanning of the website. FIG. 6 is a flow diagram 600 illustrating a requesting for a manual scanning of a website, according to an example embodiment. The user may send a request for the manual scanning of the website. The system for determining a vulnerability of a website to security threats may receive the request at block 610. In an example embodiment, the request is received via e-mail or phone. At block 620, the system for determining a vulnerability of a website to security threats may validate the request. Upon validation, the system for determining a vulnerability of a website may perform the manual scanning of the website at block 630. At block 640, the system for determining a vulnerability of a website determines whether the website is valid. If the website is not valid, the system for determining a vulnerability of a website includes the website, i.e. the website data, into the database at block 650. After including the website into the database, as well as if the website is valid, the system for determining a vulnerability of a website sends a reply to the user at block 660. The reply may be provided via e-mail, phone, and the like.

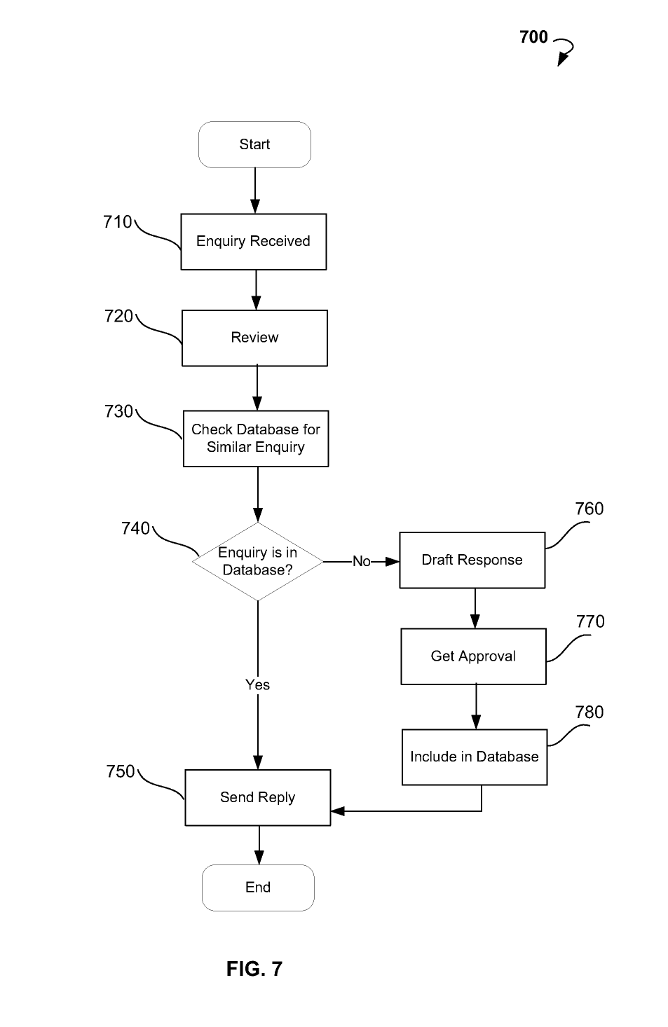

Furthermore, the user may inquire for a DDoS assessment. FIG. 7 is a flow diagram 700 illustrating a DDoS assessment enquiry, according to an example embodiment. The system for determining a vulnerability of a website to security threats may receive the enquiry at block 710. At block 720, the system for determining a vulnerability of a website to security threats may review the enquiry. Upon reviewing the enquiry, the system for determining a vulnerability of a website to security threats may check the database for a similar enquiry at block 730. In particular, at block 740, the system for determining a vulnerability of a website to security threats refers to similar enquiries previously included into the database. If the database has no similar enquiries, the system for determining a vulnerability of a website drafts a response to the user at block 760. The response may be composed based on the analysis of the enquiry received from the user. At block 770, the system for determining a vulnerability of a website may get approval of the response. At block 780, the system for determining a vulnerability of a website may include the enquiry received from the user into the database. At block 750, upon inclusion of the enquiry into the database, or if the enquiry is already present in the database, the system for determining a vulnerability of a website may send a reply to the user. The reply may be provided via e-mail, phone, and the like.

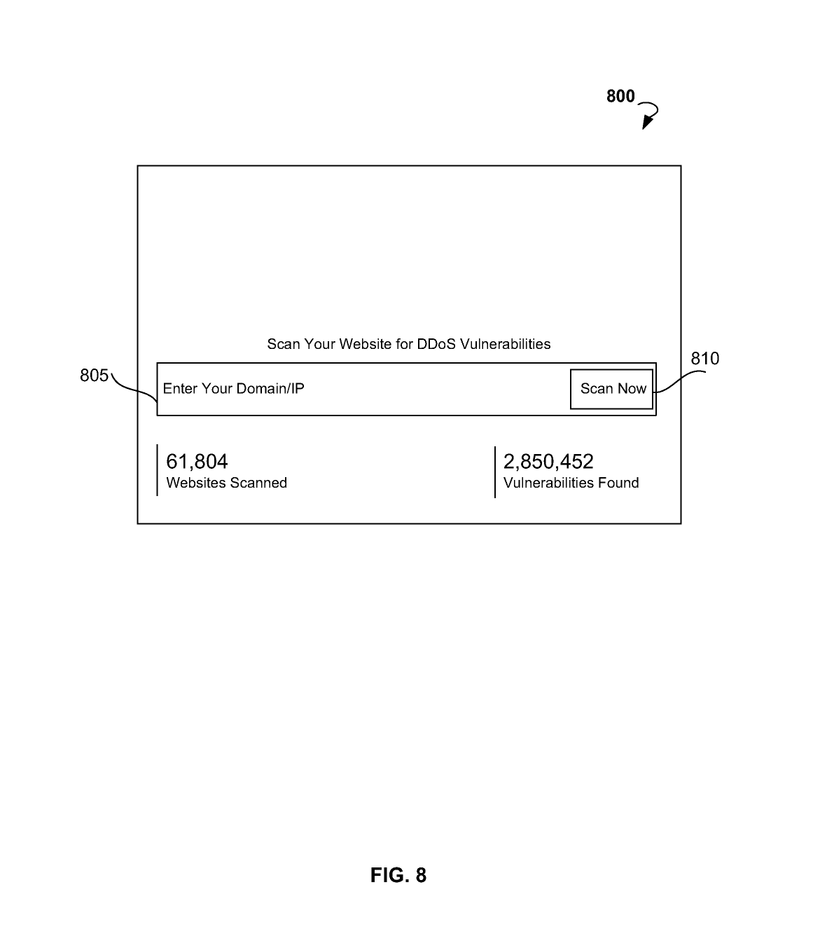

FIGS. 8-10 illustrate example UIs that may be used to implement some embodiments of the present disclosure. FIG. 8 shows a UI 800 that represents a home page associated with a system for determining a vulnerability of a website to security threats. The UI 800 may include a field 805 for a user to enter information related to a website, such as a domain name or an IP address. Upon entering the domain name or the IP address, the user may initiate scanning of the website by clicking on a “Scan Now” button 810. The UI 800 may display statistical information, such as the total number of scanned websites, the total number of found vulnerabilities, and so forth.

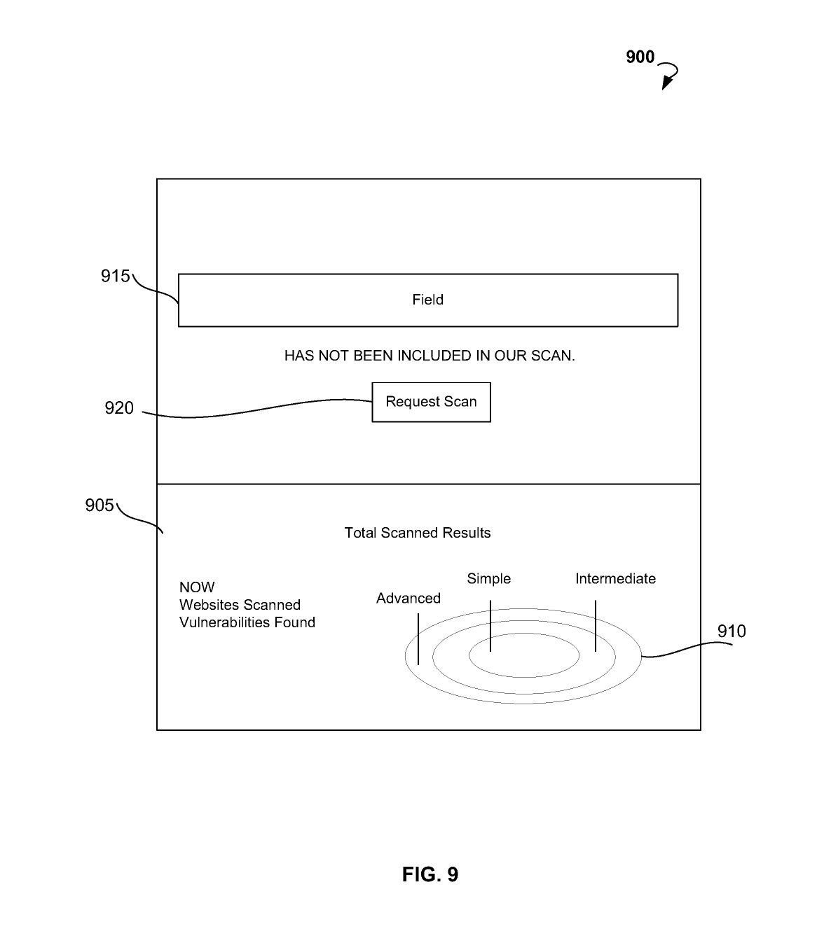

FIG. 9 shows a UI 900 that represents information related to previously scanned websites in a field 905. A diagram 910 may show comparative analysis by percentages, such as percentages of simple, intermediate, and advanced searches performed by the system for determining a vulnerability of a website to security threats. The user may enter information related to a website into a field 915. In response to entering the information, the user may be informed that the website has not yet been scanned and information related to the website is not present in a database. The user may press a “Request Scan” button 920 to initiate scanning of the website.

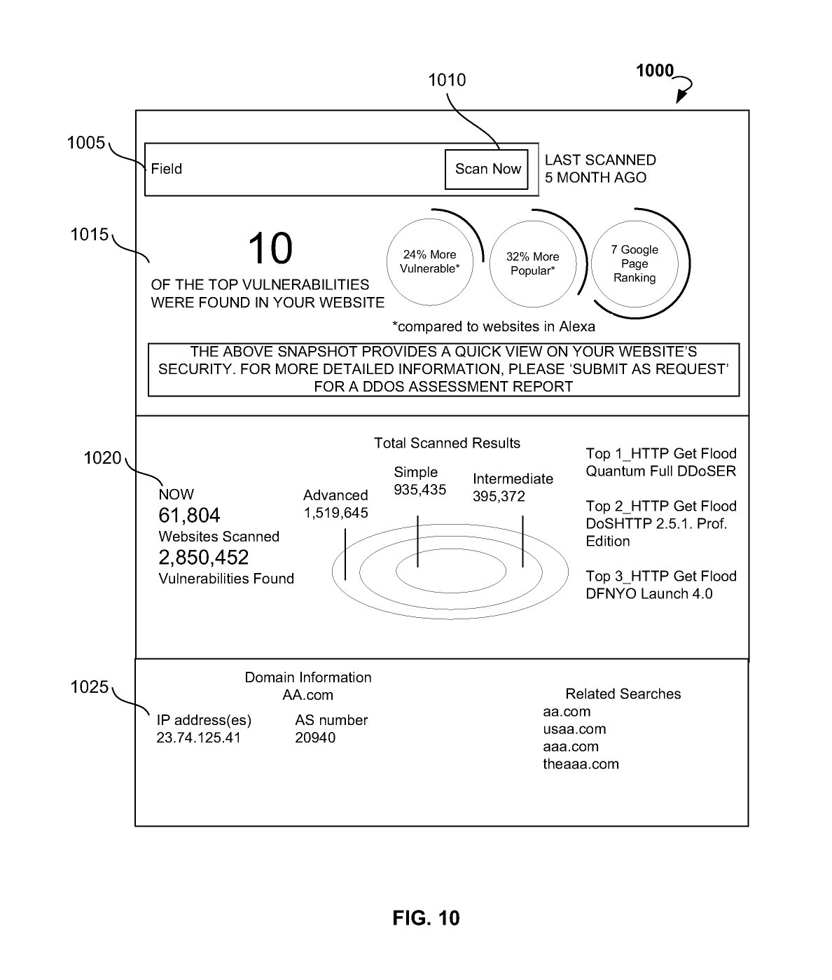

FIG. 10 shows a UI 1000 that shows scanning results. The user may enter information related to a website into a field 1005. The user may press a “Scan Now” button 1010 to initiate scanning of the website. The UI 1000 may display information related to last scan of the website. The UI 1000 may display scanning results in a field 1015, such as top 10 vulnerabilities found on the website, comparative analysis by percentages (percentage of vulnerability and popularity of the website compared to websites in Alexa Ranking), Google page ranking, and so forth. A field 1020 may represent information related to previously scanned websites, such as the total number of scanned websites, the total number of found vulnerabilities, comparative analysis by percentages, such as percentages of simple, intermediate, and advanced searches performed by the system for determining a vulnerability of a website to security threats, and so forth. A field 1025 may display domain information of the scanned website, such as an IP address, an AS number, and so forth. The field 1025 may further display a list of related searches.

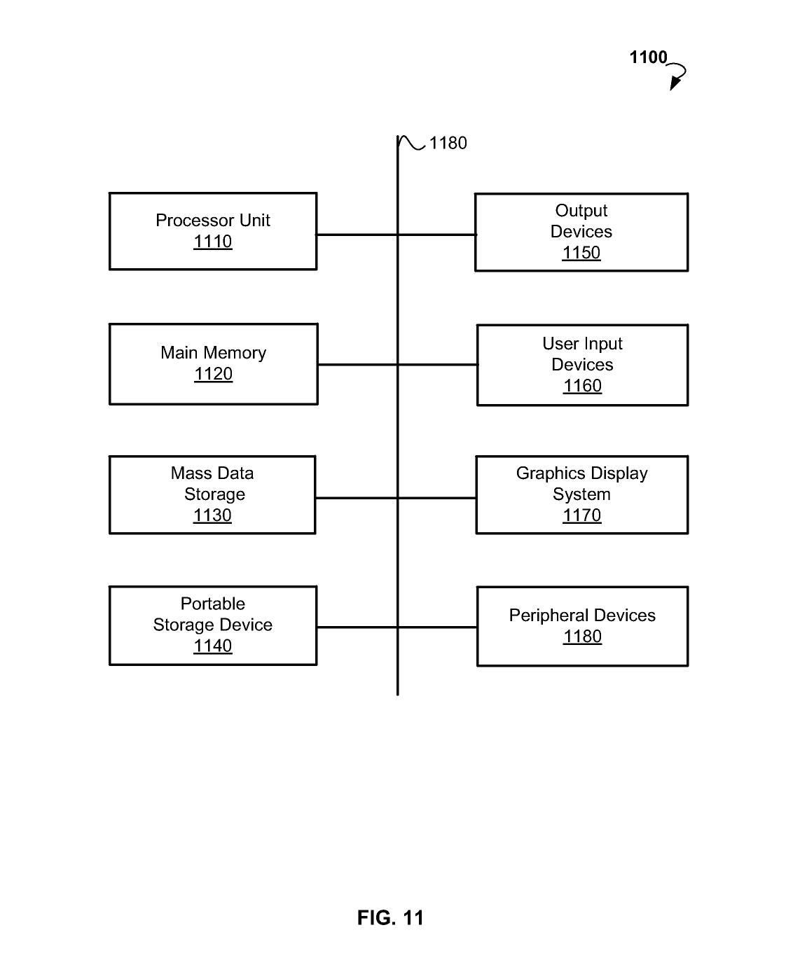

FIG. 11 illustrates an exemplary computer system 1100 that may be used to implement some embodiments of the present disclosure. The computer system 1100 of FIG. 11 may be implemented in the contexts of the likes of computing systems, networks, servers, or combinations thereof. The computer system 1100 of FIG. 11 includes one or more processor units 1110 and main memory 1120. Main memory 1120 stores, in part, instructions and data for execution by processor units 1110. In this example, main memory 1120 stores the executable code when in operation. The computer system 1100 of FIG. 11 further includes a mass data storage 1130, portable storage device 1140, output devices 1150, user input devices 1160, a graphics display system 1170, and peripheral devices 1180.

The components shown in FIG. 11 are depicted as being connected via a single bus 1180. The components may be connected through one or more data transport means. Processor unit 1110 and main memory 1120 are connected via a local microprocessor bus, and the mass data storage 1130, peripheral device(s) 1180, portable storage device 1140, and graphics display system 1170 are connected via one or more input/output (I/O) buses.

Mass data storage 1130, which can be implemented with a magnetic disk drive, solid state drive, or optical disk drive, is a non-volatile storage device for storing data and instructions for use by processor unit 1110. Mass data storage 1130 stores the system software for implementing embodiments of the present disclosure for purposes of loading that software into main memory 1120.

Portable storage device 1140 operates in conjunction with a portable non-volatile storage medium, such as a flash drive, floppy disk, compact disk (CD), digital video disc (DVD), or USB storage device, to input and output data and code to and from the computer system 1100 of FIG. 11. The system software for implementing embodiments of the present disclosure is stored on such a portable medium and input to the computer system 1100 via the portable storage device 1140.

User input devices 1160 can provide a portion of a UI. User input devices 1160 may include one or more microphones, an alphanumeric keypad, such as a keyboard, for inputting alphanumeric and other information, or a pointing device, such as a mouse, a trackball, stylus, or cursor direction keys. User input devices 1160 can also include a touchscreen. Additionally, the computer system 1100 as shown in FIG. 11 includes output devices 1150. Suitable output devices 1150 include speakers, printers, network interfaces, and monitors.

Graphics display system 1170 includes a liquid crystal display (LCD) or other suitable display device. Graphics display system 1170 is configurable to receive textual and graphical information and process the information for output to the display device.

Peripheral devices 1180 may include any type of computer support device to add additional functionality to the computer system.

The components provided in the computer system 1100 of FIG. 11 are those typically found in computer systems that may be suitable for use with embodiments of the present disclosure and are intended to represent a broad category of such computer components that are well known in the art. Thus, the computer system 1100 of FIG. 11 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN and other suitable operating systems.

The processing for various embodiments may be implemented in software that is cloud-based. In some embodiments, the computer system 1100 is implemented as a cloud-based computing environment, such as a virtual machine operating within a computing cloud. In other embodiments, the computer system 1100 may itself include a cloud-based computing environment, where the functionalities of the computer system 1100 are executed in a distributed fashion. Thus, the computer system 1100, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 1100, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for determining a vulnerability of a website to at least one security threat, the method comprising:
providing a user interface (UI);
receiving, via the UI, website data associated with the website;
based on the website data, probing the website with at least one request, the at least one request including at least one security threat signature;
receiving at least one response from the website;
comparing the at least one response to at least one expected response for the at least one request;
based on the comparison, determining the at least one security threat; and
reporting results of the determination for review.

2. The method of claim 1, wherein the at least one request includes at least one of the following: a Hypertext Transfer Protocol (HTTP) request, a Hypertext Transfer Protocol Secure (HTTPS) request, and a Transmission Control Protocol (TCP) request; and
wherein the security threat includes a Distributed Denial of Service (DDoS) attack.

3. The method of claim 1, wherein the results of determination are reported to a user associated with the website.

4. The method of claim 3, wherein report includes at least one of the following: a list of top vulnerabilities and a comparative analysis of the website with respect to at least one similar website.

5. The method of claim 4, wherein the at least one similar website is determined based on data received from a third party web traffic data provider.

6. The method of claim 1, further comprising providing a management portal.

7. The method of claim 1, wherein the results are provided in a predetermined format.

8. The method of claim 1, wherein the results include further information associated with the at least one security threat.

9. The method of claim 1, further comprising advertising further services associated with the at least one security threat.

10. The method of claim 1, wherein the at least one security threat signature is received from a database or a third party provider.

11. The method of claim 1, further comprising:
determining whether previously generated results exist for the website; and
based on the determination, selectively providing the previously generated results.

12. The method of claim 1, further comprising ranking the at least one security threat.

13. The method of claim 1, further comprising classifying the at least one security threat into categories based on corresponding threat levels.

14. The method of claim 1, wherein at least one security threat signature includes at least one of the following: a code, a name, a category, a publication date, an emergence of the attack, a geo location of a botnet, a severity, a gravity of impact, and an attack pattern.

15. The method of claim 1, wherein probing of the website with the at least one request is performed within a predetermined time period to prevent the website from implementing countermeasures.

16. The method of claim 1, wherein the results include at least one of the following: a brief description of the results, threats, and risks.

17. The method of claim 1, further comprising analyzing the at least one security threat on a predetermined periodic basis.

18. A system for determining a vulnerability of a website to at least one security threat, the system comprising:
a processor configured to:
provide a user interface (UI);
receive, via the UI, website data associated with the website;
based on the website data, probe the website with at least one request, the at least one request including at least one security threat signature;
receive at least one response from the website;
compare the at least one response to at least one expected response for the at least one request;
based on the comparison, determine the at least one security threat; and
report results of the determination for review.

19. The system of claim 18, wherein the at least one request includes at least one of the following: a Hypertext Transfer Protocol (HTTP) request, a Hypertext Transfer Protocol Secure (HTTPS) request, and a Transmission Control Protocol (TCP) request; and
wherein the security threat includes a Distributed Denial of Service (DDoS) attack.

20. A non-transitory processor-readable medium having embodied thereon a program being executable by at least one processor to perform a method for determining a vulnerability of a website to at least one security threat, the method comprising:
providing a user interface (UI);
receiving, via the UI, website data associated with the website;
based on the website data, probing the website with at least one request, the at least one request including at least one security threat signature;
receiving at least one response from the website;
comparing the at least one response to at least one expected response for the at least one request;
based on the comparison, determining the at least one security threat; and
reporting results of the determination for review.
